(19) United States
(12) Patent Application Publication
(10) Pub. No.: US 2007/0178920 A1
(43) Pub. Date: Aug. 2, 2007

(54) Communication System capable of Remotely Controlling a Multimedia Device

(76) Inventors: Po-Chih Lin, Taipei Hsien (TW); Chia-Yang Weng, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/379,055

(22) Filed: Apr. 17, 2006

(30) Foreign Application Priority Data
Jan. 27, 2006 (TW) 095103539

(51) Int. Cl. H04Q 7/20

(52) U.S. Cl. 455/466

(57) ABSTRACT

A system capable of remotely controlling a multimedia device through the Internet includes a remote control device including a first network module electrically connected to the Internet, a local device including a second network module electrically connected to the Internet, a database for storing settings data of the local device, and a software installed in the remote control device including a transformation code for interpreting commands outputted from the first network module to the second network module into a plurality of command contents to update the database.

### BACKGROUND OF THE INVENTION

1. Field of the Invention

The present invention provides a communication system, and more particularly, a communication system capable of remotely controlling a multimedia device.

2. Description of the Prior Art

As multimedia and digital storing technologies have become more highly developed, multimedia devices provide more and more functions. For recording video, a digital multimedia device transforms a video program into digital signals to store the digital signals in a hard drive or other non-volatile storage devices, such as a CD, a DVD, etc, so that the video program can be saved. In addition, a user can schedule to record a TV program, such as a ball game live broadcast, a soap opera, etc., so that the user can enjoy the program at his leisure.

By scheduling the recording of a TV program, the user need not stay in front of a TV set to control start and end of the TV program. However, if the user is not home but wants to set or amend a schedule of the TV program occasionally, the user cannot change settings of a prior art multimedia device.

### SUMMARY OF THE INVENTION

It is therefore a primary objective of the claimed invention to provide a communication system capable of remotely controlling a multimedia device.

An exemplary embodiment of a communication system capable of remotely controlling a multimedia device comprises a remote control device and a local device. The remote control device comprises a first transceiver for outputting or receiving signals, a first decoding unit coupled to the first transceiver for interpreting signals received by the first transceiver as output commands, an output unit coupled to the first decoding unit for outputting signals corresponding to the output commands, a control signal reception unit for receiving control signals, and a first coding unit coupled to the first transceiver and the control signal reception unit for transforming the control signals received by the control signal reception unit into a plurality of packets sent to the first transceiver according to a specified format. The local device comprises a second transceiver for exchanging signals with the first transceiver, a second decoding unit coupled to the second transceiver for interpreting signals received by the second transceiver as control commands according to the specified format, a memory unit coupled to the second decoding unit for storing the control commands generated by the second decoding unit, a second coding unit coupled to the second transceiver and the memory unit for generating a plurality of packets sent to the second transceiver according to a storing status of the memory unit, and a control unit coupled to the memory unit for controlling the multimedia device according to the control commands stored in the memory unit.

An exemplary embodiment of a system capable of remotely controlling a multimedia device through the Internet comprises a remote control device comprising a first network module electrically connected to the Internet, a local device comprising a second network module electrically connected to the Internet, a database for storing settings data of the local device, and a software installed in the remote control device comprising a transformation code for interpreting commands outputted from the first network module to the second network module into a plurality of command contents to update the database.

An exemplary embodiment of a communication system capable of remotely controlling a multimedia device comprises a remote control device and a local device. The remote control device comprises a first transceiver for outputting or receiving signals, a control signal reception unit for receiving control signals, an output unit for outputting signals corresponding to the output commands, and a chipset comprising a first decoding unit coupled to the first transceiver for interpreting signal received by the first transceiver as output commands and a first coding unit couple to the first transceiver unit and the control signal reception unit for transforming the control signals reception unit into a plurality of packets sent to the first transceiver according to the specified format. The local device comprises a second transceiver for exchanging signals with the first transceiver, a memory unit for storing the control commands generated by the second decoding unit, a control unit coupled to the memory unit for controlling the multimedia device according to the control commands stored in the memory unit, and a second chipset comprising a second decoding unit couple to the second transceiver for interpreting signals received by the second transceiver as control commands according to the specified format and a second coding unite coupled to the second transceiver and the memory unit for generating a plurality of packets sent to the second transceiver according to a storing status of the memory unit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a communication system capable of remotely controlling a multimedia device in accordance with the present invention.

FIG. 2 illustrates a schematic diagram of a communication system capable of setting video recording functions by e-mails.

### DETAILED DESCRIPTION

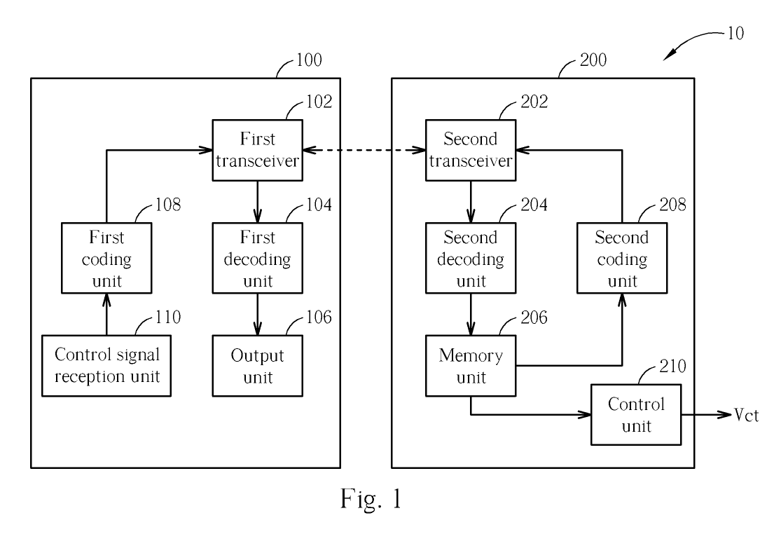

Please refer to FIG. 1, which illustrates a schematic diagram of a communication system 10 capable of remotely controlling a multimedia device in accordance with the present invention. The communication system 10 includes a remote control device 100 and a local device 200. The remote control device 100 controls operations of the local device 200 with a specified communication protocol, and includes a first transceiver 102, a first decoding unit 104, an output unit 106, a first coding unit 108, and a control signal reception unit 110. The first transceiver 102 outputs and receives signals through a wired or wireless network. The first decoding unit 104 interprets signals received by the first transceiver 102 as output commands, and transmits the output commands to the output unit 106 for outputting corresponding signals. The control signal reception unit 110 receives and transmits control signals to the first coding unit 108. The first coding unit 108 transforms the control signals received by the control signal reception unit 110 into a plurality of packets according to a specified format to the first transceiver 102 for transmitting to the local device 200. The local device 200 controls the multimedia device according to the packets outputted from the remote control device 100, and reports an operation status to the remote control device 100. The local device 200 includes a second transceiver 202, a second decoding unit 204, a memory unit 206, a second coding unit 208, and a control unit 210. The second transceiver 202 exchanges signals with the first transceiver 102. The second decoding unit 204 interprets signals received by the second transceiver 202 into control commands, and stores the control commands in the memory unit 206. According to a storing status of the memory unit 206, the second coding unit 208 generates a plurality of packets sent to the remote control device 100 through the second transceiver 202. The control unit 210 outputs a control signal Vct for controlling the multimedia device according to the control commands stored in the memory unit 206.

In the communication system 10, when a user wants to control operations of the local device 200, the control signal reception unit 110 receives the control signals from the user, the first coding unit 108 interprets the control signals received by the control signal reception unit 110 into a plurality of packets conformed to the specified format, and the first transceiver 102 transmits the packets sent to the second transceiver 202. After the second transceiver 202 receives signals from the first transceiver 102, the second decoding unit 204 outputs and stores the control commands in the memory unit 206. The control unit 210 controls the multimedia device according to the control commands stored in the memory unit 206. Meanwhile, the second coding unit 208 transmits the storing status of the memory unit 206 to the remote control device 100 through the second transceiver 202. The remote control device 100 decodes signals reported by the local device 200 for outputting corresponding signals by the output unit 106. In other words, the local device 200 controls the multimedia device according the commands sent by the remote control device 100. A channel for exchanging signals between the first transceiver 102 and the second transceiver 202 can be a mobile communication network, the Internet, etc. Packet coding and decoding methods between the first coding unit 108 and the second decoding unit 204, and between the first decoding unit 104 and the second coding unit 208 can be implemented according to an electrical mail protocol, a short messaging protocol, or an instant messaging protocol. Therefore, the first coding unit 108 is capable of transforming the controls signals received by the control signal reception unit 110 into an e-mail, and transmitting to the local device 200 through the first transceiver 102. In this case, after the local device 200 receives the e-mail, the second decoding unit 204 can decode the control signals and stores corresponding commands in the memory unit 206.

As those skilled in the art recognize, when sending an e-mail, the e-mail is stored in a mail server temporarily. When receiving the e-mail, a receiving end connects to the mail server to download the e-mail. Therefore, the receiving end need not connect to a network all of the time, but only connect to the network to receive the e-mail as necessary. In addition, it is possible for cost-effective reason that the first decoding unit 104 and the second decoding unit 204 are integrated into a chip or chipset that deliver the same capability as the two independent units.

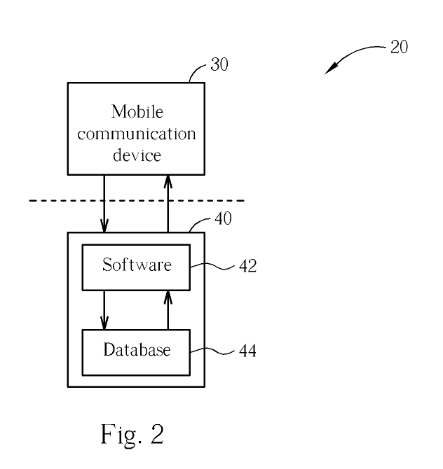

Please refer to FIG. 2, which illustrates a schematic diagram of a communication system 20 capable of setting video recording functions by e-mails. The communication system 20 includes a mobile communication device 30, and a digital multimedia device 40. The mobile communication device 30 can be a computer, a PDA, a mobile phone, a smart phone, etc., and includes units of the remote control device 100 shown in FIG. 1 for controlling the digital multimedia device 40. The digital multimedia device 40 can record video programs, and includes software 42 and a database 44. The software 42 implements the second transceiver 202, the second decoding unit 204, the second coding unit 208, and the control unit 210 shown in FIG. 1. The database 44 implements the memory unit 206. The software 42 can timely check e-mails, interpret the e-mails, command the database 44, and report a status of the database 44 to the mobile communication device 30 with e-mails. When adding a recording schedule, a user can use the mobile communication device 30 to send an e-mail describing features of a program to be recorded, such as start and end time, quality of the program, to the digital multimedia device 40. After the digital multimedia device 40 receives the e-mail, the software 42 interprets the e-mail. If the software 42 cannot interpret the e-mail successfully, then the digital multimedia device 40 reports an error message to the mobile communication device 30. After interpreting the e-mail successfully, the software 42 increases a schedule in the database 44, and receives a report from the database 44. The database 44 reports a status, such as successful, error, etc. to the software 42. Then, the software 42 sends an e-mail to the user to inform the user of the result of adding the recording schedule.

Of course, other than adding a schedule, the user can query, amend, or delete exist schedules. When the user queries the schedules, the digital multimedia device 40 can sort data stored in the database 44 first, and the user designates data to be queried with the mobile communication device 30. Or, the user designates data to be queried with the mobile communication device 30, and the digital multimedia device 40 reports corresponding data. Therefore, the user can use the mobile communication device 30 to send an e-mail describing a schedule to be queried to the digital multimedia device 40. After the digital multimedia device 40 receives the e-mail, the software 42 interprets the e-mail. If the software 42 cannot interpret the e-mail successfully, then the digital multimedia device 40 reports an error message to the mobile communication device 30. After interpreting the e-mail successfully, the software 42 queries the schedule from the database 44, and sends an e-mail to the user for informing user of the result of querying the schedule.

When amending a schedule in the database 44, the user can query the schedule first, and designate data of the schedule to be amended. Then, the user uses the mobile communication device 30 to send an e-mail describing the schedule to be amended to the digital multimedia device 40. After the digital multimedia device 40 receives the e-mail, the software 42 interprets the e-mail. If the software 42 cannot interpret the e-mail successfully, then the digital multimedia device 40 reports an error message to the mobile communication device 30. After interpreting the e-mail successfully, the software 42 amends the schedule in the database 44, receives a report from the database 44, and sends an e-mail to the user to inform the user of the result of amending the schedule.

When deleting a schedule in the database 44, the user can query the schedule first, and designate the schedule to be deleted. Then, the user uses the mobile communication device 30 to send an e-mail describing the schedule to be deleted to the digital multimedia device 40. After the digital multimedia device 40 receives the e-mail, the software 42 interprets the e-mail. If the software 42 cannot interpret the e-mail successfully, then the digital multimedia device 40 reports an error message to the mobile communication device 30. After interpreting the e-mail successfully, the software 42 deletes the schedule in the database 44, receives a report from the database 44, and sends an e-mail to the user to inform the user of the result of deleting the schedule.

In summary, the present invention drafts an e-mail describing the control commands of the user and sends the email to the local device. The local device interprets and stores the control commands into the database. Therefore, using the present invention, if the user is not home but wants to set or amend a schedule of a TV program occasionally, the user can change settings of the multimedia device remotely.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A communication system capable of remotely controlling a multimedia device comprising:
a remote control device comprising:
a first transceiver for outputting or receiving signals;
a first decoding unit coupled to the first transceiver for interpreting signals received by the first transceiver as output commands;
an output unit coupled to the first decoding unit for outputting signals corresponding to the output commands;
a control signal reception unit for receiving control signals; and
a first coding unit coupled to the first transceiver and the control signal reception unit for transforming the control signals received by the control signal reception unit into a plurality of packets sent to the first transceiver according to a specified format; and
a local device comprising:
a second transceiver for exchanging signals with the first transceiver;
a second decoding unit coupled to the second transceiver for interpreting signals received by the second transceiver as control commands according to the specified format;
a memory unit coupled to the second decoding unit for storing the control commands generated by the second decoding unit;
a second coding unit coupled to the second transceiver and the memory unit for generating a plurality of packets sent to the second transceiver according to a storing status of the memory unit; and
a control unit coupled to the memory unit for controlling the multimedia device according to the control commands stored in the memory unit.

2. The communication system of claim 1, wherein the first coding unit transforms the control signals received by the control signal reception unit into a plurality of packets sent to the first transceiver according to the specified format conforming to an electrical mail protocol.

3. The communication system of claim 2, wherein the second decoding unit interprets signals received by the second transceiver as the control commands according to the electrical mail protocol.

4. The communication system of claim 1, wherein the first coding unit transforms the control signals received by the control signal reception unit into a plurality of packets sent to the first transceiver according to the specified format conforming to a short message service protocol.

5. The communication system of claim 4, wherein the second decoding unit interprets signals received by the second transceiver as the control commands according to the short message service protocol.

6. The communication system of claim 1, wherein the first coding unit transforms the control signals received by the control signal reception unit into a plurality of packets sent to the first transceiver according to the specified format conforming to an instant messaging protocol.

7. The communication system of claim 6, wherein the second decoding unit interprets signals received by the second transceiver as the control commands according to the instant messaging protocol.

8. The communication system of claim 1, wherein the second coding unit generates the plurality of packets sent to the second transceiver according to an electrical mail protocol.

9. The communication system of claim 8, wherein the first decoding unit interprets signals received by the first transceiver as the output commands according to the electrical mail protocol.

10. The communication system of claim 1, wherein the second coding unit generates the plurality of packets sent to the second transceiver according to a short message service protocol.

11. The communication system of claim 10, wherein the first decoding unit interprets signals received by the first transceiver as the output commands according to the short message service protocol.

12. The communication system of claim 1, wherein the second coding unit generates the plurality of packets sent to the second transceiver according to an instant messaging protocol.

13. The communication system of claim 12, wherein the first decoding unit interprets signals received by the first transceiver as the output commands according to the instant messaging protocol.

14. A system capable of remotely controlling a multimedia device through the Internet comprising:
a remote control device comprising a first network module electrically connected to the Internet;
a local device comprising a second network module electrically connected to the Internet;
a database for storing settings data of the local device; and
a software installed in the remote control device comprising a transformation code for interpreting commands outputted from the first network module to the second network module into a plurality of command contents to update the database.

15. The system of claim 14, wherein the first network module and the second network module are chips having functions of network communication.

16. The system of claim 14, wherein the settings data corresponds to programs, start and end time, and quality of a video to be recorded.

17. The system of claim 14, wherein the remote control device and the local device are communicated through a mail server storing mails sent by the second network module.

18. The system of claim 14, wherein the commands conform to an electrical mail protocol.

19. The system of claim 18, wherein the software amends columns of the database according to the electrical mail protocol.

20. A communication system capable of remotely controlling a multimedia device comprising:
a remote control device comprising:
a first transceiver for outputting or receiving signals;
a control signal reception unit for receiving control signals;
an output unit for outputting signals corresponding to the output commands; and
a chipset comprising a first decoding unit coupled to the first transceiver for interpreting signal received by the first transceiver as output commands and a first coding unit couple to the first transceiver unit and the control signal reception unit for transforming the control signals reception unit into a plurality of packets sent to the first transceiver according to the specified format; and
a local device comprising:
a second transceiver for exchanging signals with the first transceiver;
a memory unit for storing the control commands generated by the second decoding unit;
a control unit coupled to the memory unit for controlling the multimedia device according to the control commands stored in the memory unit; and
a second chipset comprising a second decoding unit couple to the second transceiver for interpreting signals received by the second transceiver as control commands according to the specified format and a second coding unite coupled to the second transceiver and the memory unit for generating a plurality of packets sent to the second transceiver according to a storing status of the memory unit.
